(19) United States
(12) Patent Application Publication
(10) Pub. No.: US 2016/0218936 A1
(43) Pub. Date: Jul. 28, 2016

(54) METHOD AND SYSTEM FOR ESTABLISHING AND MANAGING A UNIFIED INTERFACE FOR A PLURALITY OF CLOUD NETWORKED DATABASES

(71) Applicant: Inango Systems Ltd., Kfar Saba (IL)

(72) Inventors: Boris SHEHTER, Kfar-Saba (IL); Jonathan MASEL, Tzofit (IL)

(21) Appl. No.: 15/005,028

(22) Filed: Jan. 25, 2016

Related U.S. Application Data
(60) Provisional application No. 62/108,089, filed on Jan. 27, 2015.

(51) Int. Cl. H04L 12/24; H04L 29/08

(52) U.S. Cl. CPC H04L 41/22; H04L 67/1044

(57) ABSTRACT

A method and system for establishing and managing a unified interface for a plurality of cloud networked databases are provided herein. The method may include: establishing a unified interface for a plurality of cloud networked databases, each database configured to store content associated with a plurality of accounts, each account being further associated with at least one user; linking content of similar accounts at different databases, to create a cumulative account, wherein similar accounts being accounts associated with same users or having indicated as associated therewith; and providing a unified view of all content associated with a specified cumulative account, responsive to a single data query from a user associated with the cumulative account.

### CROSS REFERENCE TO RELATED APPLICATIONS

This application the benefit of U.S. Provisional Patent Application No. 62/108,089, filed on Jan. 27, 2015, which is incorporated herein in its entirety.

### FIELD OF THE INVENTION

The present invention relates generally to the field of cloud networked databases and in particular to interfacing with such databases in a unified manner.

### BACKGROUND OF THE INVENTION

Prior to setting forth a short discussion of the related art, it may be helpful to set forth definitions of certain terms that will be used hereinafter.

The term “cloud networked database” as used herein is defined as a model of data storage where the digital data is stored in logical pools, the physical storage spans multiple servers (and often locations), and the physical environment is typically owned and managed by a hosting company. These cloud storage providers are responsible for keeping the data available and accessible, and the physical environment protected and running. People and organizations buy or lease storage capacity from the providers to store end user, organization, or application data. Cloud networked databases may be accessed through a co-located cloud compute service, a web service application programming interface (API) or by applications that utilize the API, such as cloud desktop storage, a cloud storage gateway server or Web-based content management systems.

The term “data integration” as used herein is defined as the process of combining data residing in different sources and providing users with a unified view of these data. This process becomes significant in a variety of situations, which include both commercial (when two similar companies need to merge their databases) and scientific (combining research results from different bioinformatics repositories, for example) domains. Data integration appears with increasing frequency as the volume and the need to share existing data explodes.

With the availability of cloud storage today, many people have multiple accounts and use multiple vendors (often to maximize free storage). As a result, the multiple-accounts—multiple vendor reality leads to fragmented data, spread across many sites that can become a extremely difficult to manage. Most Cloud storage accounts provide storage for raw data only and do not allow, for example, streaming of multi-media files directly to mobile. The result is a huge duplication of storage.

Privacy is a growing issue as data servers do not encrypt the data being stored by users.

There is no easy way to buy our own drives and add storage capacity. Thus cloud users become extremely dependent of their cloud storage providers.

It would be therefore advantageous to provide a platform that enables accessing all accounts on many service provides of a specific user in a seamless manner.

### SUMMARY OF THE INVENTION

Some embodiments of the present invention provide a method and a system for establishing and managing a unified interface for a plurality of cloud networked databases are provided herein. The method may include: establishing a unified interface for a plurality of cloud networked databases, each database configured to store content associated with a plurality of accounts, each account being further associated with at least one user; linking content of similar accounts at different databases, to create a cumulative account, wherein similar accounts being accounts associated with same users or having indicated as associated therewith; and providing a unified view of all content associated with a specified cumulative account, responsive to a single data query from a user associated with the cumulative account.

According to some embodiments of the present invention, the method may further include providing unified functionality for all cloud networked databases so that each of the cloud networked databases is associated with a similar set of functions.

According to some embodiments of the present invention, the method may further include generating group accounts wherein each of the group accounts enable each of a plurality of group users to have a similar view of the content stored over the cloud networked databases.

According to some embodiments of the present invention, the method may further include generating group accounts wherein each of the group accounts enable each of a plurality of group users to have similar functionalities applied to the content stored over the cloud networked databases.

According to some embodiments of the present invention, the method may further include updating the cumulative accounts based on updates to accounts and users over time.

### BRIEF DESCRIPTION OF THE DRAWINGS

For a better understanding of the invention and in order to show how it may be implemented, references are made, purely by way of example, to the accompanying drawings in which like numerals designate corresponding elements or sections. In the accompanying drawings:

FIG. 1 is a block diagram illustrating the architecture of a system in accordance with some embodiments of the present invention; and

FIG. 2 is a flowchart illustrating the method in accordance with some embodiments of the present invention.

The drawings together with the following detailed description make the embodiments of the invention apparent to those skilled in the art.

### DETAILED DESCRIPTION OF THE INVENTION

It is stressed that the particulars shown are for the purpose of example and solely for discussing the preferred embodiments of the present invention, and are presented in the cause of providing what is believed to be the most useful and readily understood description of the principles and conceptual aspects of the invention. In this regard, no attempt is made to show structural details of the invention in more detail than is necessary for a fundamental understanding of the invention. The description taken with the drawings makes apparent to those skilled in the art how the several forms of the invention may be embodied in practice.

Before the embodiments of the invention are explained in detail, it is to be understood that the invention is not limited in its application to the details of construction and the arrangement of the components set forth in the following descriptions or illustrated in the drawings. The invention is applicable to other embodiments and may be practiced or carried out in various ways. Also, it is to be understood that the phraseology and terminology employed herein is for the purpose of description and should not be regarded as limiting.

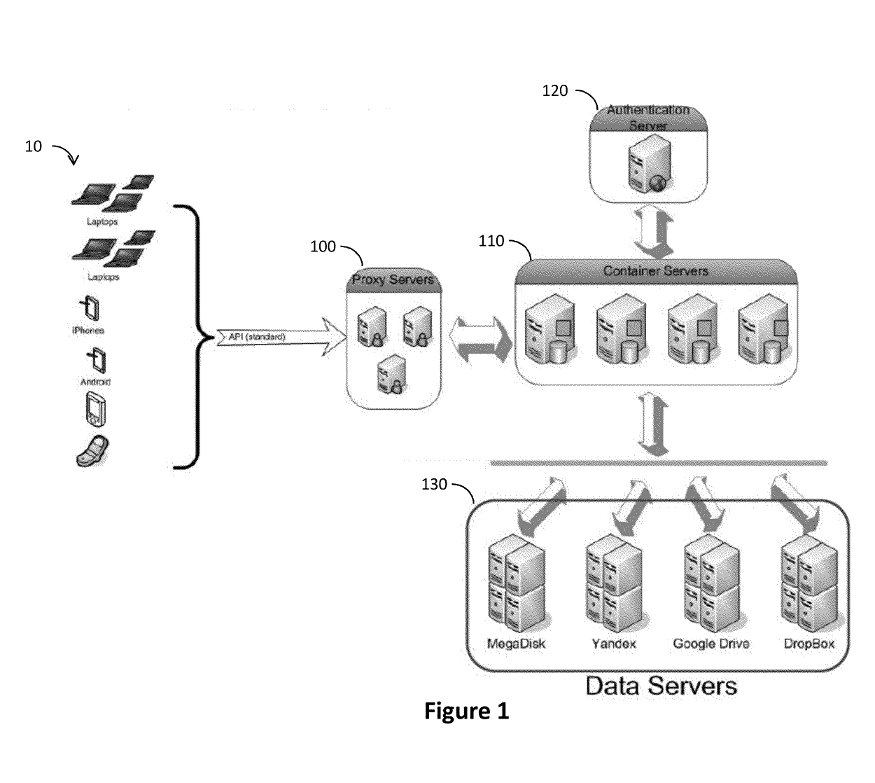

FIG. 1 shows a possible architecture of the system in accordance with some embodiments of the present invention. The system may include at least one computer proxy server 100 configured to: establish a unified interface for a plurality of cloud networked databases 130, each database configured to store content associated with a plurality of accounts, each account being further associated with at least one user; link content of similar accounts at different databases, to create a cumulative account, wherein similar accounts being accounts associated with same users or having indicated as associated therewith. The system further includes one or more computer clients 10 configured to provide a unified view of all content associated with a specified cumulative account, responsive to a single data query made to computer proxy server 100 from a user associated with the cumulative account. Proxy servers 100 may be front-end to all user requests and may be replicated for very large user bases. Container servers 110 may be used as interface between proxy servers 100 and database servers 130. Container servers 110 are configured to manage information about files and versions. Container servers 110 may also be replicated for very large user bases. Optionally, authentication server 120 may be used to check user permission and account details.

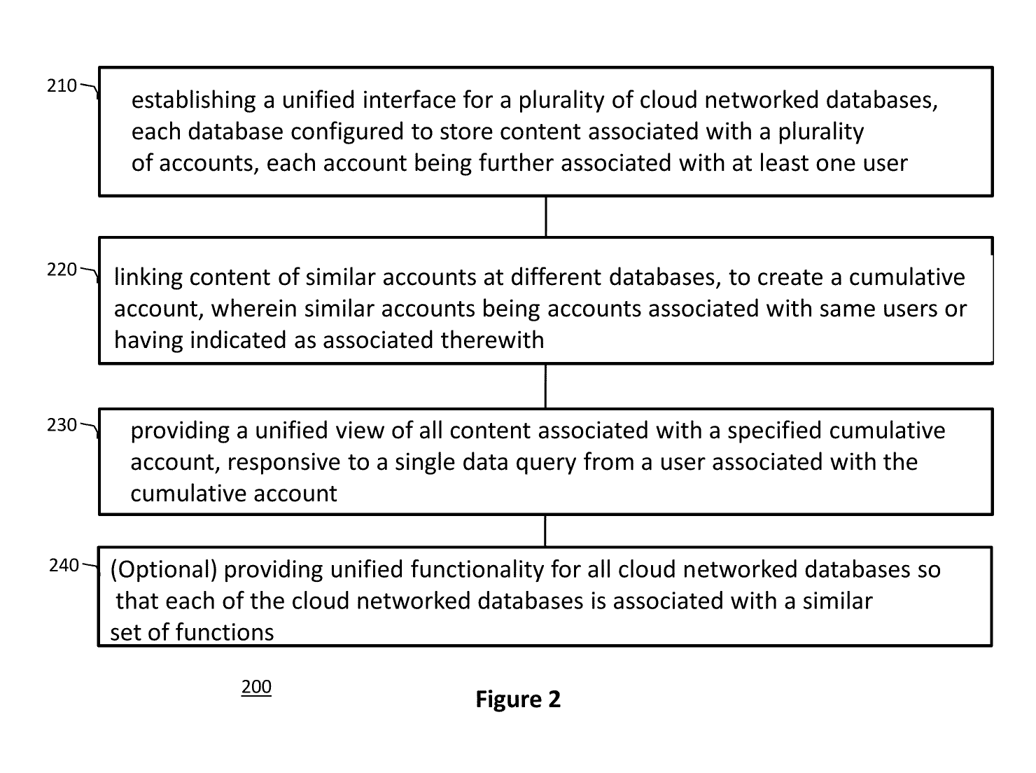

FIG. 2 is a flowchart illustrating the method 200 in accordance with some embodiments of the present invention. Method 200 may include the following steps: establishing a unified interface for a plurality of cloud networked databases, each database configured to store content associated with a plurality of accounts, each account being further associated with at least one user 210; linking content of similar accounts at different databases, to create a cumulative account, wherein similar accounts being accounts associated with same users or having indicated as associated therewith 220; and providing a unified view of all content associated with a specified cumulative account, responsive to a single data query from a user associated with the cumulative account 230. Optionally, method 200 may further include the step of providing unified functionality for all cloud networked databases so that each of the cloud networked databases is associated with a similar set of functions 240.

Following below is a detailed implementation of the aforementioned architecture. It is understood that other implementation are possible. In accordance with some embodiments of the present invention, a “Ring” represents a mapping between the names of entities stored on disk and their physical location. There are separate rings for accounts, containers, and objects. When other components need to perform any operation on an object, container, or account, they interact with the appropriate ring to determine its location in the cluster.

The “Ring” concept may operate zones, devices, and partitions, although these terms may not correspond to their usual meanings. Ring creation is discussed in the following paragraphs. Assuming there are four computers which should be unified in a cluster. Database server documentation refers to these computers as nodes, devices, or drives. Any of such terms means an application server that listens on some port. For Database server it is Account.

Server, Container Server, and Object Server. In fact, several application server instances can run on a single host (assuming they use different listening ports). Each instance is counted as a node, device, or drive.

So we are building the ring for accounts cluster out of four devices. The first step is to determine the number of partitions that will be in the ring. Database server partition is not a real file system partition; it is just a small part of a cluster's file system and resides in a dedicated directory on a host. The number of partitions must be a power of two. It is recommended to have a minimum of 100 partitions per device/drive.

Choose 1024 (2̂10) as the number of partitions for the cluster. Note that in this example it is assumed all devices have disks of equal size.

Next step is to determine the number of replicas and zones. The number of replicas controls how many copies of each partition will be in a cluster. Currently it is recommended to use three zones. It means that every partition in the cluster will be kept on 3 devices. Zones are provided with cluster data isolation. A zone could represent a cabinet, a switch, a datacenter, or even a country. Each replica of a partition is guaranteed to reside in a different zone—it means that the number of zones must be not less than the number of replicas. Let's choose for the cluster four zones (i.e., each device in its own zone).

Now we should build the ring using a database server-ring-builder command. It will distribute the partitions across the drives in the ring. For the example cluster, each device will contain 768 partitions (out of 1024). 768 partitions per drive are calculated as: 3/4*1024(<number_of_replicas>/<number_of_devices>*<number_of_partitions>).

It is easy to distribute the partitions in this simple example, but in general case the calculations are much more complex (if number of zones is less than number of devices, or if disks in devices are of different size, and the like).

The ring itself is just two data structures stored in files that are read into memory by database server upon startup. The first data structure is a table of devices in the ring (cluster). It looks like (some service fields are stripped):

ID IP address TCP port Name

The second data structure is an array of tables. The array length equals to the number of replicas. Each array entry is a table and corresponds to one replica:

Partition #1 2 . . . 1024

Device ID 0 2 . . . 1

This table maps the partition number to a device where it is kept—Device ID points to an entry for the first data structure. Each replica has its own mapping. If we go over the array of tables for our simple example with a given partition, we get 3 nodes/devices where the partition is.

How is the Ring used?

When it is needed to request application server in a cluster, the Ring helps to determine an application server instance to which the request is to be delivered.

In some embodiments of the present invention, there are three resources: account, container, and object. Account contains containers, and container contains objects. So, path to an account is just <account>, path to a container is <account>/<container>, and path to an object is <account>/<container>/<object>.

When a query of Account Server, Container Server, or Object Server, is required, a path to the account, container, or object, is prepared and supplied to a corresponding ring.

The ring takes the supplied path in the form of <account>[/<container>[/<object>]] and constructs a string HASH_PREFIX/<account>[/<container>[/<object>]]HASH_SUFFIX. Values for HASH_PREFIX and HASH_SUFFIX are from/etc/swift/swift.conf. Next, the ring computes MD5 hash for the new string.

For example, if we need to query Container Server for container CasualContainer in AUTH_test account, the ring will compute MD5 hash for fhskmzsxzj/AUTH_test/CasualContainereoriptkmvv. (here HASH_PREFIX is fhskmzsxzj, and HASH_SUFFIX is eoriptkmvv).

MD5 hash for the string is 0x6ce344408f55300409bcd53a4125f6a3.

As the number of partitions is 1024, the ring takes 10 high-order bits from the MD5 hash (10—it is the value of the power). For our example it is 0x1b3, or 435 in decimal. And 435 is the number of partition where CasualContainer resides.

Final step for the ring is to map a computed partition number to a list of devices. The list length equals the number of replicas in a cluster.

The ring partitions are used to distribute cluster's data among devices. Containers in the same account, and objects in the same container, can belong to a different partition and can be stored on different devices.

Implementing container or file sharing using file system link can be impossible under some circumstances. For example, if containers are in different partitions, which in turn are on different devices.

According to some embodiments, the proxy servers are built on WSGI interface/protocol, which is a special interface for Python applications. In the base, WSGI has WSGI server that binds itself on TCP port and listens for incoming connections. Between WSGI server and application server, there may be a pipeline of middleware (or filters). The pipeline is configured individually for each application server in its configuration file. All these components run in the same OS process.

Middleware (filters) can do anything with HTTP request—it can modify HTTP header, or even tamper with request body. Moreover, it is up to filter discretion whether to pass a request further to the pipeline, or respond on behalf of application.

Authentication

In a development environment, some embodiments of the present invention may not use external authentication service (like Authentication server). Instead, it may use TempAuth middleware in front of Proxy Server. TempAuth middleware handles all authentication requests, that is Proxy Server does not even touch authentication process.

TempAuth authentication process is as follows:

1. User sends login and password to authentication URL.

2. TempAuth intercepts the request, verifies it and responds with authentication token and storage

URL. Storage URL resides on the same host. Proxy Server does not handle this request.

3. User sends request to storage URL and supply authentication token.

4. TempAuth passes request with authentication token and supply a callback for an application.

5. Proxy Server receives request with authentication token and carry out a callback to verify token.

For production environment, database server uses external authentication service—Authentication server. Authentication process in this case is slightly different from TempAuth. Instead of TempAuth middleware, there is Authentication server middleware that interacts with Authentication server.

In accordance with some embodiments of the present invention, Proxy Server is an entry point for all client's requests to database server. It dispatches requests to a corresponding server. Database server Proxy Server always receives relative path which in general looks like:/v1/<account>/<container>/<object>, for example /v1/AUTH_test/MyContainer/my_file.

It should be noted that <object>may contain forward slashes.

The Proxy Server determines what server (Account Server, Container Server, Object Server) should handle the request. To do this, Proxy Server splits relative path into four components: version, account, container and object. Version component seems do not play a useful role.

If there are account, container and object components, then the request should be handled by Object Server. If there are account and container components only, then the request should be handled by Container Server. If there is an account component only, then the request should be handled by Account Server.

Proxy Server may use the ring corresponding to the required application server to determine nodes to which the request is to be sent.

By way of example, to integrate Google Drive™ into database server, Container and Object Servers should be modified. Both of these servers are “virtual” in sense that they do not store files from Google Drive on a local disk. Instead, they contact Google Drive on each request.

To successfully access Google Drive, several keys are required:

1. Client Id—specifies Application ID (identifies application to Google).

2. Client Secret—specifies Application token (also identifies application).

3. Access Token—identifies a user (token lifetime is 1 hour)

4. User Token—it is used to obtain a new access token (in Google terms it is a refresh token). It is valid until a user revokes it.

Access and user tokens can be simultaneously used from different hosts.

The first two keys are intended to be the same for all users. The third and forth keys are unique for each user for each account.

These keys are stored in a special service container which is intended to be per-user. It stores information about a user's tokens to access external clouds. The container uses a standard SQLite database with an additional table for Google Drive (more tables will be added in future for other clouds).

The Google Drive table contains columns:

1. Account Id. It is used by database server internally only.

2. Container Name. This is the name of container attached to Google Drive. For example, gd1 or GoogleDrive3.

3. Client Id. Issued by Google. Required to access user's Google Drive account.

4. Client Secret. Issued by Google. Required to access user's Google Drive account.

5. Access Token. Issued by Google. Required to access user's Google Drive account.

6. User Token. Issued by Google. Identifies an user to Google.

Special service container supports operations:

1. Create record. It creates a new record in Google Drive table.

Input: Container Name, Client Id, Client Secret, Access Token, Refresh Token.

Output: Ok, if a new record is created; Error, if a record with Container Name already exists.

2. Update record. It updates an existing record in Google Drive table.

Input: Container Name, [Client Id, [Client Secret, [Access Token, [Refresh Token]]]].

Output: Ok, if a record was updated; Error, if a record with Container Name does not exist.

3. Delete record. It deletes an existing record from Google Drive table.

Input: Container Name.

Output: Ok, if a record was deleted; Error, if a record with Container Name does not exist.

4. Query record. It returns information about a record by name.

Input: Container Name.

Output: Client Id, Client Secret, Access Token, Refresh Token, if a record exists; Error, if a record with Container Name does not exist.

All service container operations are used by database server internals only. External database server API cannot manipulate the service container's Google Drive table.

Note about Update record operation. This operations main usage is to update an access token which has limited lifetime.

There are two ways to accomplish integration. They are distinct in who is in charge of determining whether a requested object is in external cloud: Container/Object Server or Proxy Server. The former is an original solution to Google Drive integration, while the latter is a new proposal.

According to one embodiment, Container/Object Server is the entity which queries a special service container for user account information.

When Container/Object Server receives a request, it extracts a container's name from the request URL. Then it queries a service container (Google Drive table) for information about extracted container's name. If a special container replies with an error, then the request is not for external cloud, and it is processed as usual.

If a special container replies with information, then the request is for external cloud. In this case Container/Object Server goes directly to an external cloud and does not touch a local disk.

Request to an external cloud may be formed with the keys received from a special container.

If, during requesting an external cloud, access token needs to be refreshed, then Container/Object Server refreshes it and updates user account information in service container with a new access token.

To query a special container from Container/Object Server, the Ring for containers is required. But all Rings are on Proxy Server only, all other servers do not use the Ring at all and even do not have access to it. Because of this, a new method is proposed.

According to a second embodiment, Proxy Server is the entity which queries a special service container for user account information. The service container is serviced by Container Server.

When Proxy Server receives a request and verifies an authorization token, it extracts a container's name from the request URL.

Then it queries a service container (Google Drive table) for information about extracted container's name. If a special container replies with an error, then the request is not for external cloud, and it is processed as usual.

If a special container replies with information, then the request is for external cloud. In this case Proxy Server adds access keys from received information to the HTTP header, and sends the request unmodified (except some new keys in the header) to Container/Object Server.

Container/Object Server checks HTTP header for special keys and if they are found, the Server goes directly to an external cloud and does not touch a local disk.

If during requesting an external cloud, access token needs to be refreshed, then Container/Object Server refreshes it and sends a new access token back to Proxy Server in HTTP header. Proxy Server checks it and updates user account information in service container accordingly.

According to another embodiment of the invention, in a case that a specified file has already been uploaded, when some other user wants to upload the specified file, the specified file can be simply copied on server, reducing traffic and network overheads.

According to yet another embodiment of the invention, in a case that a user wishes to download a specific large file or play it and the specific file exists both on the server and on PCs of other users as well, the specific file may be loaded from a number of sources and allowing much more faster download/streaming

As will be appreciated by one skilled in the art, aspects of the present invention may be embodied as a system, method or an apparatus. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The aforementioned flowchart and block diagrams illustrate the architecture, functionality, and operation of possible implementations of systems and methods according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only. The principles and uses of the teachings of the present invention may be better understood with reference to the accompanying description, figures and examples. It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described. Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention may be implemented in the testing or practice with methods and materials equivalent or similar to those described herein. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method comprising:
establishing a unified interface for a plurality of cloud networked databases, each database configured to store content associated with a plurality of accounts, each account being further associated with at least one user;
linking content of similar accounts at different databases, to create a cumulative account, wherein similar accounts being accounts associated with same users or having indicated as associated therewith; and
providing a unified view of all content associated with a specified cumulative account, responsive to a single data query from a user associated with the cumulative account.

2. The method according to claim 1, further comprising providing unified functionality for all cloud networked databases so that each of the cloud networked databases is associated with a similar set of functions.

3. The method according to claim 1, further comprising generating group accounts wherein each of the group accounts enable each of a plurality of group users to have a similar view of the content stored over the cloud networked databases.

4. The method according to claim 1, further comprising generating group accounts wherein each of the group accounts enable each of a plurality of group users to have similar functionalities applied to the content stored over the cloud networked databases.

5. The method according to claim 1, further comprising updating the cumulative accounts based on updates to accounts and users over time.

6. A system comprising:
a computer server configured to:
establish a unified interface for a plurality of cloud networked databases, each database configured to store content associated with a plurality of accounts, each account being further associated with at least one user;
link content of similar accounts at different databases, to create a cumulative account, wherein similar accounts being accounts associated with same users or having indicated as associated therewith; and
a computer client configured to provide a unified view of all content associated with a specified cumulative account, responsive to a single data query made to said computer server from a user associated with the cumulative account.

7. The system according to claim 6, wherein the computer server is further configured to provide unified functionality for all cloud networked databases so that each of the cloud networked databases is associated with a similar set of functions.

8. The system according to claim 6, wherein the computer server is further configured to generate group accounts wherein each of the group accounts enable each of a plurality of group users to have a similar view of the content stored over the cloud networked databases.

9. The system according to claim 6, wherein the computer server is further configured to generate group accounts wherein each of the group accounts enable each of a plurality of group users to have similar functionalities applied to the content stored over the cloud networked databases.

10. The system according to claim 6, wherein the computer server is further configured to update the cumulative accounts based on updates to accounts and users over time.
